(19) United States
(12) Patent Application Publication
(10) Pub. No.: US 2015/0088665 A1
(43) Pub. Date: Mar. 26, 2015

(54) COMPUTERIZED SYSTEMS AND METHODS RELATED TO CONTROLLED CONTENT OPTIMIZATION

(71) Applicant: AOL Advertising Inc., New York, NY (US)

(72) Inventor: Niklas KARLSSON, Mountain View, CA (US)

(73) Assignee: AOL Advertising Inc.

(21) Appl. No.: 14/498,494

(22) Filed: Sep. 26, 2014

Related U.S. Application Data
(60) Provisional application No. 61/882,845, filed on Sep. 26, 2013.

(51) Int. Cl. G06Q 30/02

(52) U.S. Cl. CPC G06Q 30/0275
USPC 705/14.71

(57) ABSTRACT

Systems, methods, and computer-readable media are disclosed for controlling the display of digital content to users over an electronic network, such as the Internet. In accordance with one implementation, a computer-implemented method is provided that includes receiving at least one partition and at least one associated candidate promotion and receiving control data and previous engagement data associated with the at least one partition. The method further comprises, for each partition, generating an adjusted model of the control data over a first time period, generating a bid price control adjustment value and a bid price value associated with an earlier time period, and generating a bid uncertainty control adjustment value and a bid uncertainty value associated with an earlier time period. The method further comprises generating a bid price and a bid uncertainty for each candidate promotion, performing a market clearing process using at least one candidate promotion, and serving at least one of the candidate promotions.

### CROSS-REFERENCE TO RELATED APPLICATION(S)

This application claims the benefit of U.S. Provisional Patent Application No. 61/882,845, filed on Sep. 26, 2013, the entire disclosure of which is expressly incorporated herein by reference to its entirety.

### BACKGROUND

1. Technical Field

The present disclosure relates generally to the field of data processing and online advertising and digital content systems. More particularly, and without limitation, the present disclosure relates to computer-implemented systems and methods for controlling the display of digital content and advertisements to users over an electronic network, such as the Internet. The present disclosure also relates to systems and methods for optimizing promotion of such content and advertisements.

2. Background Information

Publishers of content on the Internet tend to be dependent upon advertising for revenue. For example, various types of web sites, blogs, social networks, and web-based service sites use advertising as a significant source of income to offset the costs associated with offering content and/or services to their users. When a user requests a specific web page, a corresponding web server (either alone or in conjunction with other servers), may identify advertisements or other content to be displayed as part of the web page. For example, a server may attach instructions for a client computer to request an appropriate advertisement from an ad server. Additionally, or alternatively, instructions may be provided to insert an image or other content associated with the ad into the web page.

News web sites are one type of web site that rely on advertisements for generating revenue. Such sites may provide various pieces of electronic content for users, including articles, editorials, and/or videos, for example. The content may be independently generated by staff writers and/or compiled from other sources. On news web sites and other content-rich sites, care is often taken to deliver relevant advertisements to users who are reading or viewing the content on the web site. Such web sites may receive money from advertisers, such as manufacturers or resellers, in order to display such content. In some situations, the content may be associated with a “budget” or “goal,” such as a desired maximum number of clicks on, engagement with, or impressions of, that content or related content. For example, if a manufacturer wishes to reach 10,000 potential customers regarding a new product offering, the manufacturer may pay the web site owner for 10,000 impressions of an advertisement for that product.

In order to adaptively select content promotions that will yield the desired number of impressions, clicks, or engagements, in the desired amount of time, a bidding system may be used where each content promotion bids on particular promotion slots in an “auction” process. Each content promotion's bid in each action may be determined based on past performance (for example, click through rate (“CTR”) or other interaction metrics) of the content promotion, the particular promotion slot, or other attributes.

However, a poorly-chosen system for generating bids for this auction process can lead to a small number of promotions winning a disproportionately high amount of bids. This can cause problems because advertising budgets for those promotions can be used up too quickly. Other content promotions that do not win many auctions thus may not have enough engagement data with which to generate economically sound bids likely to win later auctions. This may create a self-perpetuating cycle by which content promotions that are not highly successful to begin with receive relatively few impressions, and may bid too much for each received impression.

In view of the foregoing, there is a need for improved systems and methods for generating control signals used for optimizing the display of content promotions for web sites. Moreover, there is a need for improved systems and methods for controlling the rate at which content promotions are displayed, by changing the variables used by each promotion to generate bids for the ability to appear in a particular promotion slot. One of ordinary skill will understand from this disclosure that other uses for these embodiments are possible as well.

### SUMMARY

In accordance with embodiments of the present disclosure, computer-implemented systems, methods, and computer-readable media are provided. Exemplary embodiments of the present disclosure include systems and methods for generating control signals for affecting bid data (e.g., price, allocation, and/or uncertainty) for content promotions. The control signals may be based on reference data, such as a desired level of engagement during a time period, and engagement measurements for that content promotion during a previous time period. These control signals may be utilized to affect bid data for use in an auction process. The auction process may be implemented as a market clearing process that selects the highest-bidding content promotion for display in an open promotion slot.

By way of example, a computerized method is provided, the method being implemented with at least one processor. The method comprises receiving a candidate promotion and a partition and receiving control data and previous engagement data associated with the partition. The method further comprises, for each partition, generating an adjusted model of the control data over a first time period, generating a factor based on the adjusted model and the previous engagement data, and generating bid price control and bid uncertainty control adjustments. The method further comprises generating a bid price and a bid uncertainty for each candidate promotion. The method then comprises a step of, for each open promotion slot, performing a market clearing process using eligible promotions, using bid prices and bid uncertainties associated with each eligible promotion.

Computer-readable media and systems implementing the above method are also provided for. Additional embodiments and related features of the present disclosure are described herein.

### BRIEF DESCRIPTION OF THE DRAWINGS

The accompanying drawings, which are incorporated in and constitute a part of this disclosure, illustrate several embodiments and aspects of the present disclosure, and together with the description, serve to explain certain principles of the presently disclosed embodiments.

FIG. 1 illustrates an exemplary embodiment of a system for implementing embodiments of the present disclosure.

FIG. 2 illustrates an exemplary embodiment of a control system for use with embodiments of the present disclosure.

FIG. 3 illustrates an exemplary process of exploration, exploitation, and control for a set of candidate promotions, consistent with embodiments of the present disclosure.

FIG. 4 illustrates graphs depicting a sample relationship between bid price, bid uncertainty, and impression volume resulting from each combination of bid price and bid uncertainty.

FIG. 5 illustrates an exemplary computer system for implementing embodiments of the present disclosure.

### DETAILED DESCRIPTION OF EXEMPLARY EMBODIMENTS

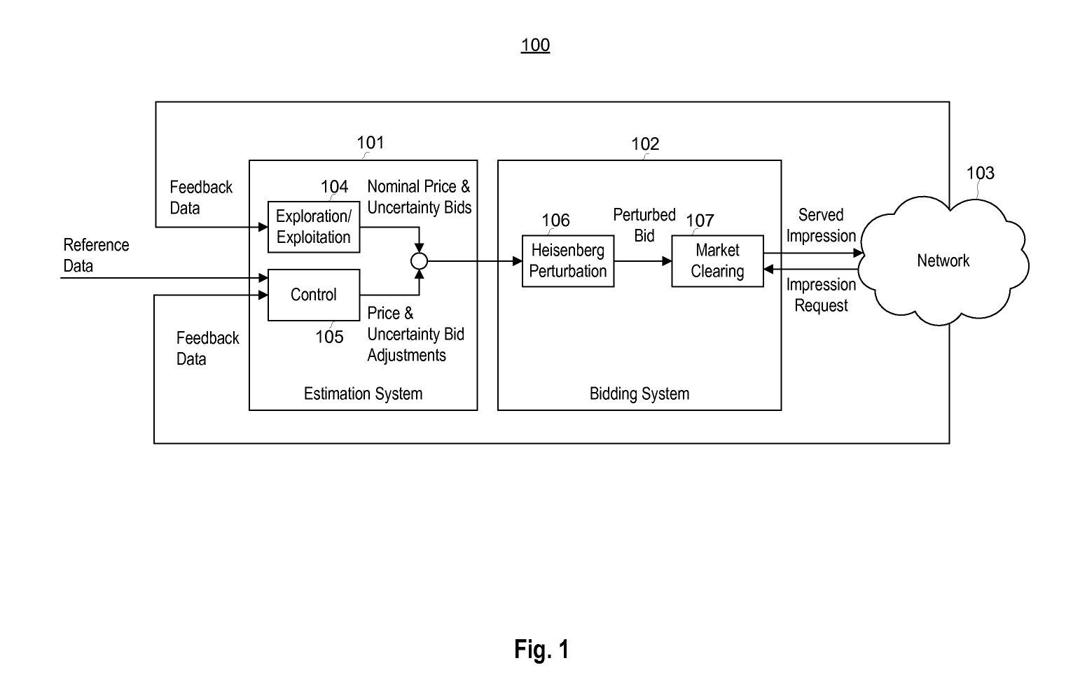

Embodiments of the present disclosure will now be described. However, it is understood that further embodiments are disclosed in FIGS. 1-5, taken together or alone.

Embodiments of the present disclosure are generally directed to systems, methods, and computer-readable media for serving content promotions (e.g., Internet advertisements, images, videos, embedded applications) to users. Promotions are selected using a market clearing process that selects a content promotion for each available promotion slot. These promotion slots may be related to a particular position on a static webpage, a dynamic (e.g., periodically updating) webpage, a web site, or the like. A promotion slot, moreover, may refer to a particular location (e.g. below a text area on a webpage) or a general location (e.g., along the left side of each webpage associated with a web site).

Embodiments of the disclosed systems, methods, and media involve receiving feedback data on engagements (e.g., clicks or other interactions) related to the exploitation of those content promotions, such as when the content promotions are promoted to users in available promotion slots. Embodiments also involve receiving goals, or “reference data,” such as a desired number of engagements for said content promotions, and adjusting factors related to the content promotions in order to meet such goals.

In some embodiments, content promotions may be assigned to particular groups or “partitions” of content promotions. Content promotions can be grouped into a content partition based on advertising campaigns associated with the content promotion. For example, if a manufacturer wants to issue a 40% discount on a particular product, the manufacturer may create a set of content promotions advertising that discount. Each of these related content promotions can be grouped into a single partition so as to avoid over-presentation of that discount to users. Partitions may also be defined based on genre. For example, content promotions that relate to stories about sporting events may be grouped into a “sports” partition while content promotions that relate to stories about international news may be grouped into an “international” partition. In some embodiments, a single content promotion can be a part of one or more partitions. So, continuing this example, a content promotion for a story about the Olympics could be a part of both the “sports” and the “international” partitions.

FIG. 1 illustrates an exemplary embodiment of a system 100 for implementing embodiments of the present disclosure. As shown in FIG. 1, system 100 includes estimation system 101, bidding system 102, and network 103. Network 103 may be implemented as any known or unknown data network, such as the Internet, an Intranet, a cellular, wireless, wired, or other network. Network 103 may also comprise devices such as web servers that contain web pages. Each web page may have one or more promotion slots for exploiting content promotions.

The modules represented in FIG. 1, in some embodiments, may be implemented based on the disclosures in U.S. Patent Application Publication No. 2010/0262497 (filed Apr. 10, 2009; titled “Systems and Methods for Controlling Bidding for Online Advertising Campaigns”) or U.S. Patent Application Publication No. 2013/0197994 (filed Nov. 5, 2012; titled “Systems and Methods for Displaying Digital Content and Advertisements over Electronic Networks”), the disclosures of which are hereby incorporated by reference herein.

Estimation system 101 and bidding system 102 may be implemented as hardware, software, firmware, or a combination thereof. Estimation system 101 can be implemented to operate in a discrete or real-time fashion. Estimation system 101 comprises two modules, exploration/exploitation module 104 and control module 105.

Exploration/exploitation module 104 receives feedback data from network 103. Feedback data, in some embodiments, comprises data associated with content promotion exploitation, such as click-through rate, engagement rate, impression rate, or the like. The data may be associated with particular groups of users (e.g., “males” or “female technology enthusiasts between the ages of 25 and 40”) and their particular interactions with particular content promotions and/or partitions of such content promotions. Exploration/exploitation module 104 is configured to generate nominal price and nominal uncertainty bids for each content promotion, based on feedback data associated with that content promotion. In some embodiments, exploration/exploitation module 104 generates prices and uncertainty bids on only one content promotion at a time, using only data associated with that particular content promotion.

Control module 105 receives feedback data from network 103 and reference data, and generates bid price control signal adjustments and bid uncertainty control signal adjustments. The reference data received by control module 105 can be received from a user or a controlling system. The reference data comprises, for example, a desired pacing (e.g., a speed) for the exploitation of the content promotions, an allocation signal (e.g., affecting how often a promotion should win an auction) associated with the content promotions for bidding in a market clearing process, or other reference data representing desired outcomes. The reference data may be determined in advance (e.g., based on an advertising contract associated with the content promotion) or may be based on a decision to promote more/fewer of one type of content promotion. In some embodiments, control module 105 generates price and uncertainty bid control signal adjustments on only one content promotion at a time, using only data associated with that content promotion, and only generates such adjustments for content promotions associated with partitions.

Bidding system 102 can be implemented to operate in a real-time fashion. Bidding system 102 comprises two modules, Heisenberg perturbation module 106 and market clearing module 107.

Heisenberg perturbation module 106 receives bid data for each content promotion from exploration/exploitation module 104 and control module 105. Bid data includes, for example, a nominal bid price, a bid allocation, or a bid uncertainty. Heisenberg perturbation module 106 calculates final bid prices based in part on the received bid data. In some embodiments, if a content promotion is associated with a partition, a final bid price for that content promotion may be calculated based on a bid price and a calculated bid control signal adjustment.

Market clearing module 107 receives a perturbed bid for each content promotion from Heisenberg perturbation module 106. Market clearing module then performs a market clearing process for each available promotion slot to determine a content promotion for promoting in that slot, and presents the content promotion to a user in that promotion slot. In some embodiments, presenting the content promotion comprises receiving an impression request from network 103, and sending it to a server on network 103 for inserting into a web page. One of skill will understand that other arrangements are possible as well.

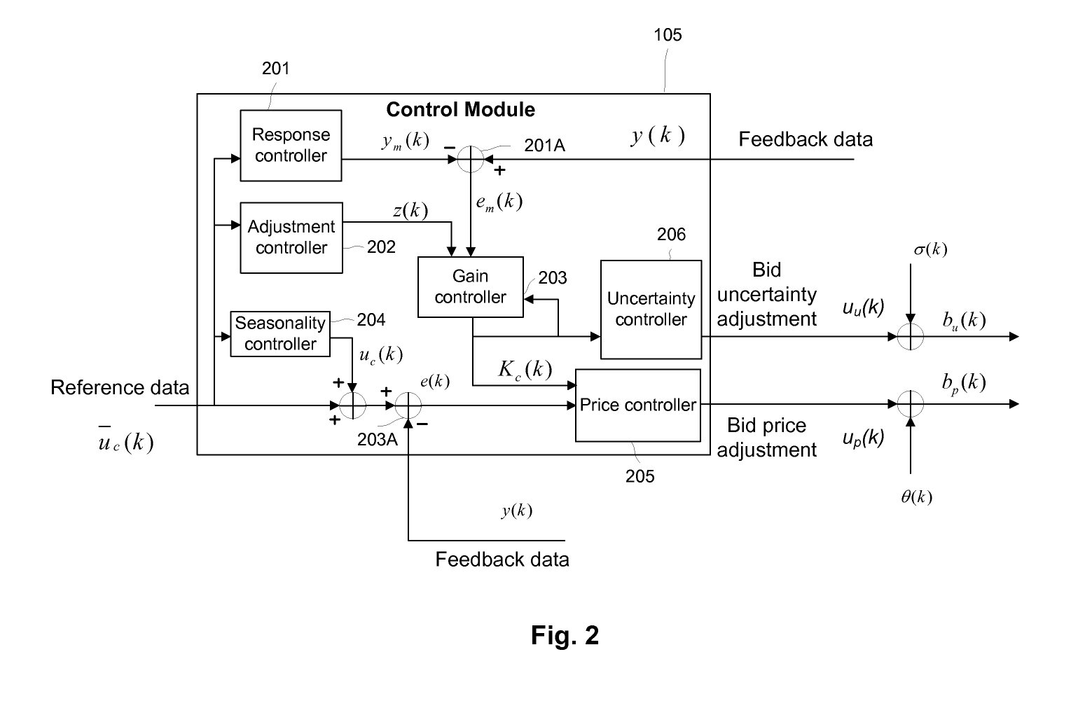

FIG. 2 illustrates an exemplary embodiment of control module 105 for use with embodiments of the present disclosure. Control module 105, in some embodiments, generates control signal adjustments only for promotions that are associated with partitions. As shown in FIG. 2, control module 105 includes a response controller 201, an adjustment controller 202, a gain controller 203, a seasonality controller 204, a price controller 205, and an uncertainty controller 206. Each of response controller 201, adjustment controller 202, gain controller 203, seasonality controller 204, price controller 205, and uncertainty controller 206 may be implemented in hardware, software, firmware, or a combination thereof.

The controllers in control module 105, in some embodiments, are designed to ensure that a plant gain factor (Kₚ)and a controller gain factor (K_{c}(k)) remain related to one another. These factors are used to calculate dynamics for control module 105 to generate the adjustments necessary to obtain the desired outcome (e.g., a particular pacing or desired number of engagements). For example, control module 105 may establish an inverse relationship between K_{c}(k) and Kₚ (e.g.,

$${K}_{c} ( k ) \approx \frac{{K}_{m}}{{K}_{p}} , {K}_{m} \neq 0 ) .$$

This inverse relationship may change in real-time and thus a change in one value (e.g., Kₚ) requires a change in the other value (e.g., K_{c}(k)). The overall input-output relationship (y(k)) of control module 105 may be represented as:

y(k)=(1+g(k))f(uₚ(k), uᵤ(k)); where
g(k) is a T-periodic function (where g(t)>−1 and g(t+T)=g(t) for all t);
uₚ(k) is a bid price adjustment; and
uᵤ(k) is a bid uncertainty adjustment.

Response controller 201 is configured to generate a desired feedback response (yₘ(k)) that will yield the desired rate of feedback for a particular promotion in a particular partition. In some embodiments, this rate may be based on the reference data (ū_{c}(k)) and may be determined in order to read this desired rate. For example, yₘ(k) may be calculated as follows:

$$\frac{d {x}_{m}}{d t} = - \frac{{\tilde{g}}_{m} ( k )}{{T}_{i}} {x}_{m} ( k ) + {\overline{u}}_{c} ( k )$$

$$and$$

$${y}_{m} ( k ) = \frac{( 1 + g ( k ) ) {\tilde{g}}_{m} ( k ) ( 1 - {\tilde{g}}_{m} ( k ) )}{{T}_{i}} {x}_{m} ( k ) + ( 1 + g ( k ) ) {\tilde{g}}_{m} ( k ) {\overline{u}}_{c} ( k ) ;$$

$$where$$

$${\tilde{g}}_{m} ( k ) = \frac{{K}_{m} ( 1 + g ( k ) )}{1 + {K}_{m} ( 1 + g ( k ) )} ,$$

and
Tᵢ is a design parameter.

Block 201A indicates that the desired feedback response yₘk) may be combined with actual feedback data (y(k)) to determine the “error” or difference (eₘ(k)) between these values. For example, eₘ(k) may be calculated by response controller 201, controller gain module 204, or any other module or device, as eₘ(k)=y(k)−yₘ(k).

Adjustment controller 202 calculates an adjustment factor (z(k)). The adjustment factor may be utilized to ensure that plant gain factor Kₚ and controller gain factor K_{c}(k) remain related to one another. Adjustment controller 202 may calculate a factor z(k) used to adjust K_{c}(k) such that this inverse proportionality holds. For example, this factor z(k) may be utilized by gain controller 203 along with the error (eₘ(k)) to calculate a new controller gain factor K_{c}(k) using partial derivatives. In some embodiments, adjustment controller 202 may calculate factor z(k) by determining:

$$\frac{d {x}_{z}}{d t} = [ \begin{matrix}- \frac{2 {\tilde{g}}_{m} ( k )}{{T}_{i}} & - \frac{{{\tilde{g}}_{m} ( k )}^{2}}{{T}_{i}^{2}} \\ 1 & 0\end{matrix} ] {x}_{z} ( k ) + [ \begin{matrix}1 \\ 0\end{matrix} ] {\tilde{u}}_{c} ( k )$$

$$and$$

$$z ( k ) = - \frac{{{\tilde{g}}_{m} ( k )}^{2}}{{K}_{m}} [ \begin{matrix}\frac{1 - 2 {T}_{i} {\tilde{g}}_{m} ( k )}{{T}_{i}} & - \frac{{{\tilde{g}}_{m} ( k )}^{2}}{{T}_{i}^{2}}\end{matrix} ] {x}_{2} ( k ) + \frac{{{\tilde{g}}_{m} ( k )}^{2}}{{K}_{m}} {\tilde{u}}_{c} ( k ) .$$

Gain controller 203 utilizes error eₘ(k) and factor z(k) to calculate a new controller gain factor K_{c}(k) to maintain the inverse relationship between controller gain factor K_{c}(k) and plant gain factor Kₚ. In some embodiments, the actual relationship between controller gain factor K_{c}(k) and plant gain factor Kₚ (i.e., the Kₘ in the above example relationship

$${K}_{c} ( k ) \approx \frac{{K}_{m}}{{K}_{p}} , {K}_{m} \neq 0 )$$

may not be known but may be approximated using partial derivatives. For example, gain controller 203 may determine controller gain factor K_{c}(k) based on the following relationship:

$$\frac{d {K}_{c}}{d t} = - γ {e}_{m} ( k ) \frac{z ( k )}{{K}_{c} ( k )} ,$$

where γ is a design parameter. One of ordinary skill will understand that there are other methods for calculating K_{c}(k).

Seasonality controller 204 is configured to generate a seasonally-adjusted reference signal u_{c}(k) based on reference data ū_{c}(k). This seasonally-adjusted signal u_{c}(k) is used to redistribute the budget for a particular content promotion over a period of time based on a known supply function. One example of a known supply function relates to network traffic over time. Internet traffic patterns in many regions of the world vary based on the time of day, day of week, or the like. For example, traffic coming from computers in North America tends to be higher during the daylight hours than during the late night hours, because most people are asleep during the latter period. Seasonality controller 204 may account for this “seasonality” or variance in content promotion engagement using a harmonic equation. In some embodiments, the seasonally-adjusted reference signal is generated using a two-harmonic equation. For example, seasonality controller 204 receives factors α_{l,1}, α_{l,2}, φ_{l,1}, and φ_{l,2} (each representing various factors selected based on particular seasonality patterns and related to partition l), and generates a seasonally-adjusted reference signal as:

$${u}_{c} ( k ) = ( {α}_{l , 1} sin ( \frac{2 π k}{24} + {φ}_{l , 1} ) + {α}_{l , 2} sin ( \frac{4 π k}{24} + {φ}_{l , 2} ) ) {\overline{u}}_{c} ( k ) ,$$

In the above equation, α_{l,1} and α_{l,2} relate to the amplitude of the signal, while φ_{l,1} and φ_{l,2} relate to the phase of the signal. In some embodiments, α_{l,1}, α_{l,2}, φ_{l,1}, and φ_{l,2} are chosen such that u_{c}(k)≧0 for all time measurements k. Other periodic functions, including other truncated Fourier series expansions of periodic functions, are possible as well. Block 203A indicates that the seasonally-adjusted signal u_{c}(k) may be combined with feedback data y(k) to determine the “error” or difference (e(k)) between these values. For example, this may be calculated by seasonality controller 204, price controller 205, or any other module or device, as

e(k)=u_{c}(k)−y(k).

Price controller 205 generates a bid price adjustment uₚ(k) based on received data. In some embodiments, price controller 205 may be implemented as a “PI controller” (also known as a “Proportional-Integral controller”) which attempts to minimize the difference between the reference data ū_{c}(k) and y(k). Price controller module 205 determines a bid price control signal uₚ(k), using controller gain factor K_{c}(k), error e(k), and other factors, including the change in time between the current update and the most recent update, previous measurements of bid price control signals, or the like. For example, price controller module 205 may receive error e(k) and controller gain factor K_{c}(k), and calculate bid price adjustment signal uₚ(k) as:

$${u}_{p} ( k ) = {K}_{c} ( k ) ( e ( k ) + \frac{1}{{T}_{i}} {\int }_{0}^{t} e ( τ ) d τ ) .$$

Uncertainty controller 206 is configured to generate a bid uncertainty adjustment uᵤ(k). The bid uncertainty adjustment uᵤ(k) may be calculated to shape the plant gain factor Kₚ as follows:

uᵤ(k)=uᵤ⁰+Kᵤ(K_{c}(k)−K_{c}⁰)²; where
uᵤ⁰ and K_{c}⁰ represent baseline values for bid uncertainty adjustment uᵤ(k) and K_{c}(k), respectively; and
Kᵤ represents a design parameter≠0.

In some embodiments, the bid price adjustment uₚ(k) and bid uncertainty adjustment uᵤ(k) are combined by a module (such as Heisenberg perturbation module 106 in FIG. 1) with the expected value and variance for the content promotion (θᵢ(k) and σⁱ(k), respectively) to generate a final bid price, bid uncertainty, and bid allocation for use in a market clearing process.

While some embodiments of the modules in control module 105 have been described above, other arrangements of the modules in control module 105 are also possible as well.

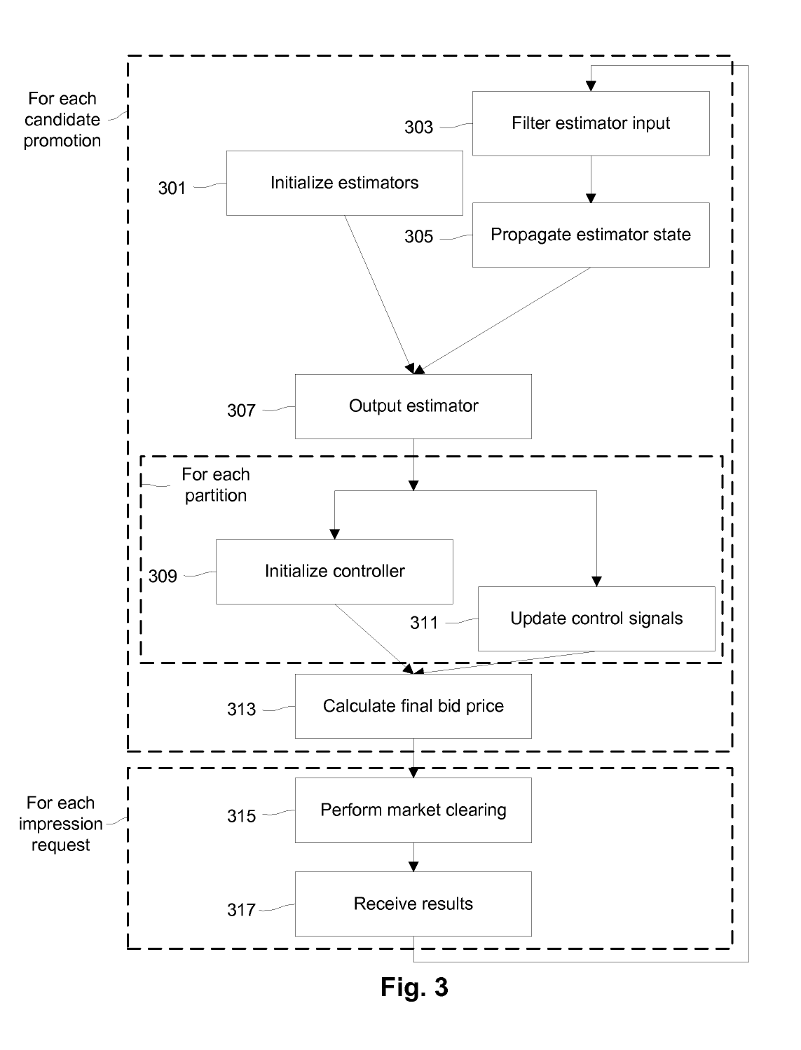

FIG. 3 illustrates an exemplary process of exploration, exploitation, and control for a set of candidate promotions. The exemplary process in FIG. 3 may be executed by one or more systems, modules, or software programs, such as that illustrated in FIG. 1 and FIG. 2.

The process in FIG. 3 begins at step 301 for each candidate promotion i that has not previously been exploited. Parameters αᵢ(k),βᵢ(k) are initialized to initial values α_{i,0},β_{i,0} to begin the exploitation, exploration, and control process. These parameters are used to generate a probability density function representing engagement rate for a candidate promotion at time k.

However, if the candidate promotion i has previously been exploited (e.g., has already been displayed to one or more users), the process instead starts at step 303, where estimator inputs, such as a time series of impression measurements ñ_{i,l}(k) or engagement volume measurements ñ_{i,C}(k), are filtered. In step 305, the estimator state is propagated based on the filtered measurements to create parameters for generating a probability density function for the expected engagement rate for the candidate promotion. For example, the parameters αᵢ(k),βᵢ(k) can be generated based on γ^{Δ}^{ₖ} (γ being a chosen factor less than 1.0, such as 0.99, and Δₖ being the difference between the current time and the time of the last measurement), initial pre-set parameters α_{i,0},β_{i,0}, earlier values of those parameters (αᵢ(k−1),βᵢ(k−1)), a filtered impression measurement ñ_{i,l}(k), a filtered volume measurement ñ_{i,C}(k), or the like. In some embodiments, one way of filtering the impression measurements ñ_{i,l}(k) and the engagement volume measurements ñ_{i,C}(k) is:

$${\tilde{n}}_{i , I} ( k ) = min ( {n}_{i , I} ( k ) , {n}_{I , max} {Δ}_{k} , {ρ}^{{Δ}_{k}} {β}_{i} ( k ) ) ;$$

$${\tilde{n}}_{i , C} ( k ) = \{ \begin{matrix}\frac{{\tilde{n}}_{i , I} ( k )}{{n}_{i , I} ( k )} {n}_{i , C} ( k ) , & if {n}_{i , I} ( k ) > {\tilde{n}}_{i , I} ( k ) \\ {n}_{i , C} ( k ) & else\end{matrix}$$

Parameters αᵢ(k),βᵢ(k) are then calculated based on the earlier values of the parameters and the filtered measurements, as:

$$[ \begin{matrix}{α}_{i} ( k ) \\ {β}_{i} ( k )\end{matrix} ] = ( 1 - {γ}^{{Δ}_{k}} ) [ \begin{matrix}{α}_{i , 0} \\ {β}_{i , 0}\end{matrix} ] + {γ}^{{Δ}_{k}} {λ}^{{Δ}_{k}} [ \begin{matrix}{α}_{i} ( k - 1 ) \\ {β}_{i} ( k - 1 )\end{matrix} ] + [ \begin{matrix}{\tilde{n}}_{i , C} ( k ) \\ {\tilde{n}}_{i , I} ( k )\end{matrix} ]$$

The process in FIG. 3 continues to step 307. Step 307 outputs an estimation of two parameters θᵢ(k) and σⁱ(k), indicating the estimated expected value and relative standard deviation of the engagement rate for the candidate promotion, respectively. In some embodiments, these values may be calculated based on the calculated parameters αᵢ(k) and βᵢ(k), as follows:

$$[ \begin{matrix}{θ}_{i} ( k ) \\ {σ}_{i} ( k )\end{matrix} ] = [ \begin{matrix}{α}_{i} ( k ) / {β}_{i} ( k ) \\ 1 / \sqrt{{α}_{i} ( k )}\end{matrix} ] .$$

After calculating the expected value and relative standard deviation of the engagement rate, the process continues to steps 309-311. Steps 309-311 are executed once for each partition l. In some embodiments, each partition l contains at least one candidate promotion i, and each candidate promotion i is a member of at most one partition l. In other embodiments, each candidate promotion i can be a member of one or more partitions. (Moreover, if a particular promotion i is not a member of any partition, the process continues to step 313 without generating control signal adjustments in steps 309 or 311.)

In step 309, a controller is initialized for each partition l that is “new” (e.g., having candidate promotions that have not yet been displayed to users). Parameters u_{l,p}(k),u_{l,a}(k), and u_{l,u}(k), representing control signal adjustments for bid price, bid allocation, and bid uncertainty, respectively, are initialized to initial values (u_{l,p}⁰,u_{l,a}⁰,u_{l,u}⁰). These parameters are used in conjunction with the expected value and variance for the content promotion (θᵢ(k) and σⁱ(k), respectively) to generate a final bid price, bid uncertainty, and bid allocation for use in a market clearing process.

However, if content promotions in partition l have already been displayed to users, the process continues to step 311. In step 311, the control signal adjustments are updated for generating a final bid price. u_{l,p}(k), u_{l,a}(k), and u_{l,u}(k) are calculated based on values such as n_{l,C}(k) (engagement volume measurements for the partition l associated with the content promotion), u_{l,a}(k−1) (allocation signal associated with the partition l during a previous time period), n_{l,C}^{ref}(k) (a “reference,” or desired, daily value for engagement for the partition l), Δₖ (the difference between the current time and the last time that a measurement was made), δₗ (a factor whose component parts include n_{l,C}^{ref} (k) and a seasonally-adjusted reference signal for n_{l,C}^{ref}(k)), and a variety of constant values. For example, these control signal adjustments may be calculated as explained above with reference to FIG. 2.

After determining the values for the control signal adjustments u_{l,p}(k),u_{l,a}(k), and u_{l,u}(k) associated with a partition l (e.g., either through calculation as explained in step 311 or through initial values as explained in step 309), these control signal adjustments may be combined with the expected value and variance (θᵢ(k)and σᵢ(k), respectively) for each content promotion, to generate a bid price and bid uncertainty for the content promotion. For example, in some embodiments, the bid price b_{i,p}(k) may be based on addition of the expected value and the bid price control signal adjustment (e.g., b_{i,p}(k)=θᵢ(k)+u_{l,p}(k)), the bid uncertainty b_{i,u}(k) may be based on addition of the expected variance and the bid uncertainty control signal adjustment (e.g., b_{i,u}(k)=σᵢ(k)+u_{l,u}(k)), and the bid allocation may be based on a calculated bid allocation control signal adjustment or a pre-set bid allocation control signal adjustment (e.g., b_{i,a}(k)=u_{l,u}(k)). These values may be combined in a variety of ways in other embodiments—such as through multiplication, division, or the like.

In some embodiments, the control signal adjustments are only used in step 313 for generating bid price, bid allocation, and bid uncertainty if the content promotion belongs to one or more partitions. If a particular content promotion does not belong to a partition l, the bid price, bid allocation, and bid uncertainty be calculated without taking control signal adjustments into account (e.g., b_{i,p}(k)=θᵢ(k), b_{i,a}(k)=1, and b_{i,u}(k)=σᵢ(k)).

After calculating the final bid price, bid allocation, and bid uncertainty for each candidate promotion, the process continues to step 315. In step 315, a process of market clearing is performed on each impression set request j. Market clearing involves, for example, generating a random bid for each eligible candidate promotion i. A candidate promotion is “eligible” if the candidate promotion is able to appear in a particular promotion slot that is part of an impression set request. Whether a candidate promotion is able to appear in a particular promotion slot may be based on, for example, the content of the content promotion and/or a web page containing the promotion slot.

Market clearing may also involve identifying the highest-bidding candidate promotion and generating a random number. If the random number is less than a factor of the bid allocation assigned to the highest-bidding candidate promotion (b_{i,a}(k)), the highest-bidding candidate promotion is assigned to the promotion set request (e.g., for presentation in the promotion slot). This process may be repeated until no eligible candidate promotions remain or until all open promotion slots are filled with candidate promotions. The identified candidate promotions are then served (e.g., presented to users on web pages) in descending order of their bid prices. For example, the content promotions can be presented to a user as part of a web page requested by that user.

In step 317, results from the presentation of the candidate promotions are gathered. For example, impression and/or engagement (e.g., click or other interaction) data are gathered. This data is then used as input to step 303, to enable generation of an estimated state for the next bid calculated related to each eligible content promotion.

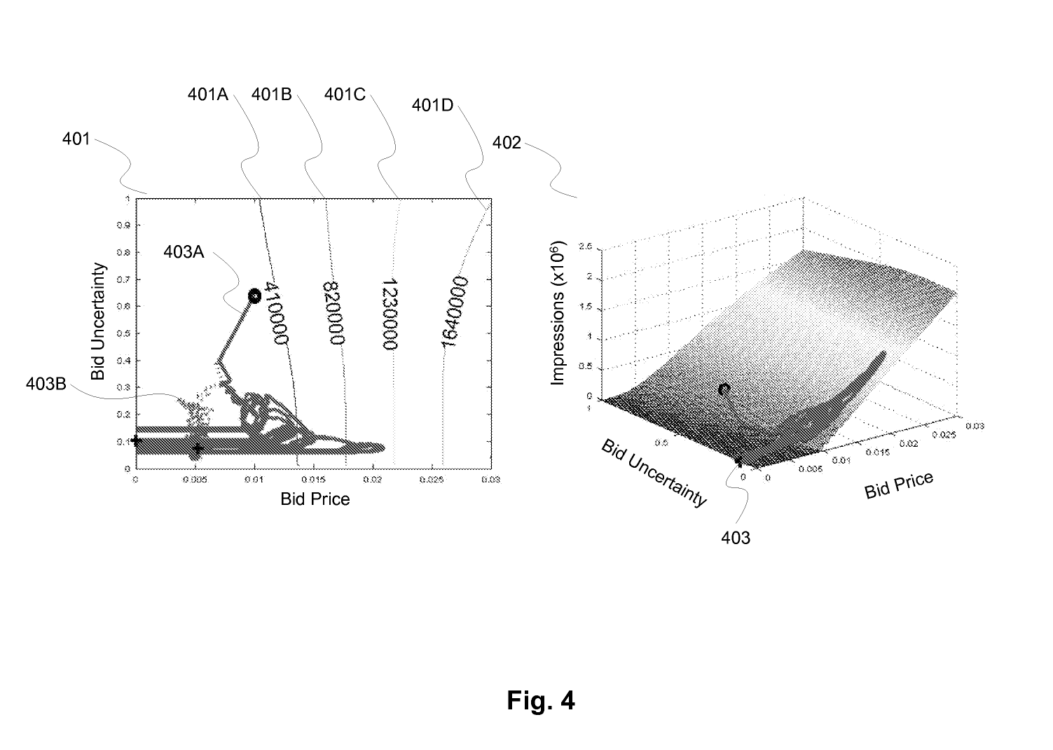

FIG. 4 illustrates graphs 401 and 402, depicting a sample relationship between bid price, bid uncertainty, and impression volume resulting from each combination of bid price and bid uncertainty. In some embodiments, graphs 401 and 402 depict the data related to a particular content promotion that has been subject to a market clearing process. The bid price and bid uncertainty are the values used in the market clearing process, and the impression data depicted in graphs 401 and 402 relate to the actual number of impressions received for each combination of bid price and bid uncertainty in the market clearing process.

Graph 401 is a contour graph depicting the relationship between bid price (X-axis), bid uncertainty (Y-axis), and impressions related to each combination of bid price and bid uncertainty (contour lines 401A, 401B, 401C, and 401D). Line 403A depicts the particular values of each of bid price and bid uncertainty used in a market clearing process, and line 403B represents the particular values of each estimated expected value and estimated relative standard deviation. The difference (e.g., the distance) between lines 403A and 403B represents the bid price adjustment uₚ and bid uncertainty adjustment uᵤ. Contour lines 401A, 401B, 401C, and 401D represent impression estimates for a content promotion. The contour lines 401A-401D may be based on the impressions depicted in line 403, and may represent expected impressions. For example, contour line 401C illustrates that the content promotion can expect to receive 1,230,000 impressions with a bid price of approximately 0.022 and a bid uncertainty no larger than approximately 0.75. Contour line 401A, in contrast, shows a relationship between bid price and bid uncertainty, illustrating the content promotion can expect to receive 410,000 impressions with a bid price of approximately 0.014, but with a more widely varying bid uncertainty in order to win a constant number of impressions. Graph 402 is a surface graph depicting the same relationship as in graph 401.

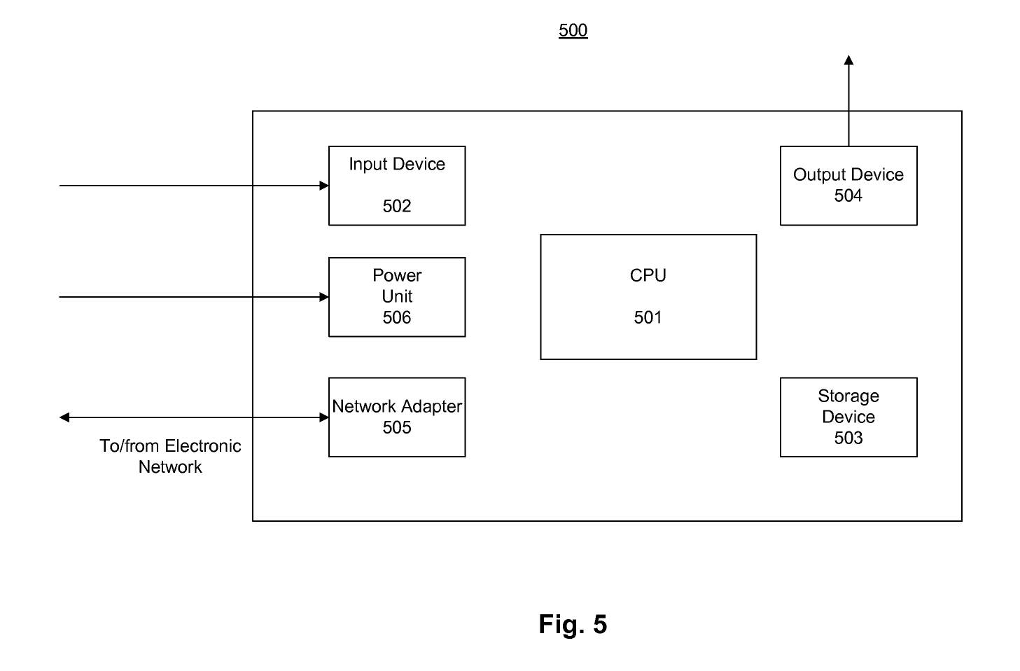

FIG. 5 illustrates an exemplary computer system 500 for implementing embodiments consistent with the present disclosure. Variations of computer system 500 may be used for implementing devices, algorithms, or other systems, described in this specification or in FIGS. 1-4. Such devices include those that would be understood or contemplated by those skilled in the art. Persons skilled in the art will also understand, from the present disclosure, that the components represented in FIG. 5 may be duplicated, omitted, or modified.

As shown in FIG. 5, exemplary computer system 500 may include a central processing unit 501 (also referred to as an electronic processor) for managing and processing data, as well as operations, consistent with the present disclosure. Computer system 500 also includes storage device 503. Storage device 503 comprises optical, magnetic, signal, and/or any other type of storage device. Computer system 500 may also include network adapter 505. Network adapter 505 allows computer system 500 to connect to electronic networks, such as the Internet, a local area network, a wide area network, a cellular network, a wireless network, or any other type of network. Computer system 500 also includes power unit 506, which may enable computer system 500 and its components to receive power and operate fully.

In some embodiments, computer system 500 may also include input device 502, which receive input from users and/or modules or devices. Such modules or devices may include, but are not limited to, keyboards, mice, trackballs, trackpads, scanners, cameras, and other devices which connect via Universal Serial Bus (USB), serial, parallel, infrared, wireless, wired, or other connections. Computer system 500 also includes output device 504, which transmit data to users and/or modules or devices. Such modules or devices may include, but are not limited to, computer monitors, televisions, screens, projectors, printers, plotters, and other recording/displaying devices which connect via wired or wireless connections.

In this disclosure, various embodiments have been described with reference to the accompanying drawings and embodiments. It will, however, be evident that various modifications and changes may be made thereto, and additional embodiments may be implemented, without departing from the present disclosure. The specification and drawings are accordingly to be regarded in an illustrative rather than restrictive sense.

For example, advantageous results may still be achieved if steps of the disclosed methods were performed in a different order and/or if components in the disclosed systems were combined in a different manner and/or replaced or supplemented by other components. Other implementations are also within the scope of the present disclosure. Further, the accompanying drawings, which are incorporated in and constitute a part of this specification, illustrate embodiments of the present disclosure and together with the description, and are similarly not restrictive.

What is claimed is:

1. A computerized method for control, the method being implemented with at least one electronic processor and comprising:
receiving at least one candidate promotion and at least one partition, at least one of the candidate promotions associated with at least one partition;
receiving control data and engagement data associated with the at least one partition, the previous engagement data associated with an earlier time period;
for each partition:
generating an adjusted model of the control data over a first time period, based on data representing a traffic pattern;
generating a bid price control adjustment value based on the adjusted model and a bid price value associated with the earlier time period;
generating a bid uncertainty control adjustment value based on the adjusted model and a bid uncertainty value associated with the earlier time period;
generating a bid price and a bid uncertainty for each candidate promotion;
for each open promotion slot, performing a market clearing process using at least one candidate promotion, using a bid price and a bid uncertainty associated with each candidate promotion; and
serving at least one of the candidate promotions based on the results of the market clearing process.

2. The method of claim 1, wherein generating a bid price and a bid uncertainty for each candidate promotion comprises:
generating a probabilistic model estimating engagement data associated with the candidate promotion, the probabilistic model associated with an expected value and an expected variance;
generating the bid price, based on the expected value and the bid price control adjustment value; and
generating the bid uncertainty value, based on the expected variance and the bid uncertainty control adjustment value.

3. The method of claim 1, wherein the market clearing process comprises:
determining that at least one candidate promotion is bidding for an impression;
for each candidate promotion bidding for the impression:
generating, based on the associated bid price value and the associated bid price control adjustment value, a nominal bid price;
generating, based on the associated bid uncertainty value and the associated bid uncertainty control adjustment value, a nominal bid uncertainty;
generating a final bid for the candidate promotion using the nominal bid price and the nominal bid uncertainty;
identifying the highest bid of the final bids;
determining if a bid allocation value associated with the candidate promotion is greater than a generated random value; and if so, outputting the candidate promotion corresponding to the highest bid.

4. The method of claim 1, wherein:
each partition is associated with a plant gain factor (Kₚ)and a controller gain factor (K_{c}(k)), where Kₚ and K_{c}(k) are related to one another in an inverse relationship; and
generating the bid uncertainty control adjustment value is further based on the controller gain factor K_{c}(k).

5. The method of claim 1, wherein the control data comprises data on a desired number of engagements for content promotions associated with a partition.

6. The method of claim 1, further comprising generating a factor based on the adjusted model and the previous engagement data, and wherein generating a bid price control adjustment value is based on the generated factor.

7. The method of claim 1, wherein:
the market clearing process is performed in response to a user requesting a web page, the web page containing at least one promotion slot, and
wherein serving the at least one candidate promotion comprises inserting the at least one candidate promotion into the at least one promotion slot on the web page.

8. A tangible computer-readable storage medium containing instructions that, when executed by at least one electronic processor, causes the at least one electronic processor to perform the following operations:
receiving at least one candidate promotion and at least one partition, at least one of the candidate promotions associated with at least one partition;
receiving control data and previous engagement data associated with the at least one partition, the previous engagement data associated with an earlier time period;
for each partition:
generating an adjusted model of the control data over a first time period, based on data representing a traffic pattern;
generating a bid price control adjustment value based on the adjusted model and a bid price value associated with the earlier time period;
generating a bid uncertainty control adjustment value based on the adjusted model and a bid uncertainty value associated with the earlier time period;
generating a bid price and a bid uncertainty for each candidate promotion;
for each open promotion slot, performing a market clearing process using at least one candidate promotion, using a bid price and a bid uncertainty associated with each candidate promotion; and
serving at least one of the candidate promotions based on the results of the market clearing process.

9. The computer-readable storage medium of claim 8, wherein generating a bid price and a bid uncertainty for each candidate promotion comprises:
generating a probabilistic model estimating engagement data associated with the candidate promotion, the probabilistic model associated with an expected value and an expected variance;
generating the bid price, based on the expected value and the bid price control adjustment value; and
generating the bid uncertainty value, based on the expected variance and the bid uncertainty control adjustment value.

10. The computer-readable storage medium of claim 8, wherein the market clearing process comprises:
determining that at least one candidate promotion is bidding for an impression;
for each candidate promotion bidding for the impression:
generating, based on the associated bid price value and the associated bid price control adjustment value, a nominal bid price;
generating, based on the associated bid uncertainty value and the associated bid uncertainty control adjustment value, a nominal bid uncertainty;
generating a final bid for the candidate promotion using the nominal bid price and the nominal bid uncertainty;
identifying the highest bid of the final bids;
determining if a bid allocation value associated with the candidate promotion is greater than a generated random value; and if so, outputting the candidate promotion corresponding to the highest bid.

11. The computer-readable storage medium of claim 8, wherein:
each partition is associated with a plant gain factor (Kₚ)and a controller gain factor (K_{c}(k)), where Kₚ and K_{c}(k) are related to one another in an inverse relationship; and
generating the bid uncertainty control adjustment value is further based on the controller gain factor K_{c}(k).

12. The computer-readable storage medium of claim 8, wherein the control data comprises data on a desired number of engagements for content promotions associated with a partition.

13. The computer-readable storage medium of claim 8, wherein the medium causes the at least one electronic processor to perform the operation of generating a factor based on the adjusted model and the previous engagement data, and
wherein generating a bid price control adjustment value is based on the generated factor.

14. The computer-readable storage medium of claim 8, wherein:
the market clearing process is performed in response to a user requesting a web page, the web page containing at least one promotion slot, and
wherein serving the at least one candidate promotion comprises inserting the at least one candidate promotion into the at least one promotion slot on the web page.

15. A system for control, comprising:
at least one electronic processor; and
a storage device that stores instructions that, when executed by the at least one electronic processor, causes the at least one electronic processor to perform the following operations:
receiving at least one candidate promotion and at least one partition, at least one of the candidate promotions associated with at least one partition;
receiving control data and previous engagement data associated with the at least one partition, the previous engagement data associated with an earlier time period;
for each partition:
generating an adjusted model of the control data over a first time period, based on data representing a traffic pattern;
generating a bid price control adjustment value based on the adjusted model and a bid price value associated with an earlier time period;
generating a bid uncertainty control adjustment value based on the adjusted model and a bid uncertainty value associated with an earlier time period;
generating a bid price and a bid uncertainty for each candidate promotion;
for each open promotion slot, performing a market clearing process using at least one candidate promotion, using a bid price and a bid uncertainty associated with each candidate promotion; and
serving at least one of the candidate promotions based on the results of the market clearing process.

16. The system of claim 15, wherein generating a bid price and a bid uncertainty for each candidate promotion comprises:
generating a probabilistic model estimating engagement data associated with the candidate promotion, the probabilistic model associated with an expected value and an expected variance;
generating the bid price, based on the expected value and the bid price control adjustment value; and
generating the bid uncertainty value, based on the expected variance and the bid uncertainty control adjustment value.

17. The system of claim 15, wherein the market clearing process comprises:
determining that at least one candidate promotion is bidding for an impression;
for each candidate promotion bidding for the impression:
generating, based on the associated bid price value and the associated bid price control adjustment value, a nominal bid price;
generating, based on the associated bid uncertainty value and the associated bid uncertainty control adjustment value, a nominal bid uncertainty;
generating a final bid for the candidate promotion using the nominal bid price and the nominal bid uncertainty;
identifying the highest bid of the final bids;
determining if a bid allocation value associated with the candidate promotion is greater than a generated random value; and if so, outputting the candidate promotion corresponding to the highest bid.

18. The system of claim 15, wherein:
each partition is associated with a plant gain factor (Kₚ)and a controller gain factor (K_{c}(k)), where Kₚ and K_{c}(k) are related to one another in an inverse relationship; and
generating the bid uncertainty control adjustment value is further based on the controller gain factor K_{c}(k).

19. The system of claim 15, wherein the instructions cause the at least one electronic processor to perform the operation of generating a factor based on the adjusted model and the previous engagement data, and
wherein generating a bid price control adjustment value is based on the generated factor.

20. The system of claim 15, wherein:
the market clearing process is performed in response to a user requesting a web page, the web page containing at least one promotion slot, and
wherein serving the at least one candidate promotion comprises inserting the at least one candidate promotion into the at least one promotion slot on the web page.
